(19) United States
(12) Patent Application Publication
(10) Pub. No.: US 2007/0268463 A1
(43) Pub. Date: Nov. 22, 2007

(54) PROJECTION DEVICE WITH SOLAR CELL PANEL

(75) Inventor: Hsiu-Ming Chang, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/563,984

(22) Filed: Nov. 28, 2006

(30) Foreign Application Priority Data
May 16, 2006 (TW) 095117251

(51) Int. Cl. G03B 21/16

(52) U.S. Cl. 353/61

(57) ABSTRACT

The present invention relates to a projection device which comprises a light source, a solar cell panel, an airflow channel, and a fan. The airflow channel is formed between the solar cell panel and the light source, while the fan is utilized to generate airflow along the airflow channel. The airflow channel can be alternatively formed between the solar cell panel and other components of the projection device. With this arrangement, the solar cell panel can convert the unused light into electric power, while simultaneously forming an airflow channel for cooling the device.

This application benefits from the priority of Taiwan Patent Application No. 095117251 filed on May 16, 2006.

### CROSS-REFERENCES TO RELATED APPLICATIONS

Not applicable.

### BACKGROUND OF THE INVENTION

1. Field of the Invention

The present invention relates to a projection device. In particular, the invention relates to a projection device that has an airflow channel, formed by a solar cell panel, to aid in cooling the interior of the device.

2. Descriptions of the Related Art

Because energy resources are limited, it is important to consider energy conservation and environmental protection while developing technology. In the area of luminescence technologies for projectors, not only should the efficiency of the light source be considered, but other factors should also be considered to enhance the entire quality of the projectors. For example, the internal light that shines from the projector needs to be covered to keep users from being irritated. In addition, a portion of light that is not provided for illumination should be diminished or if provided, it should be efficiently introduced for other purposes. Furthermore, heat generating from the light source needs to be efficiently eliminated or dissipated.

As a result of the aforementioned concerns, researchers have strived to improve the concerns individually. For instance, a specific baffle has been provided to cover internal light leakages. In this case, a solar cell panel has been provided to receive energy leakages from the light source and convert them into electric powers for use in the projection device. This improved technique is referred to as U.S. Pat. No. 6,467,910, issued on Oct. 22, 2002, wherein the solar cell panel is utilized to receive the light leaking from the light source and convert them into useful electric powers. For enhancing cooling efficiency, another design has been invented to improve the configurations of the cooling fans and the relations between the cooling fans and the light source. However, the above-mentioned improvements would add further complexities in the manufacturing processes, materials, and assembling procedures. Furthermore, the problems of light sheltering, energy utilizing, and device cooling could not be simultaneously resolved. If the aforementioned method of resolving individual problems is not considered in advance, the invention may affect other aspects, and therefore, probably reduce the expected efficiency owing to the original design.

FIG. 1 is a schematic view illustrating the componential arrangement in a conventional projector 1. The projector 1 has an optical engine 11, a lamp 13, a power board 15, a ballast 17, and two fans 19 disposed in the interior thereof. The ventilations of the fans 19 can cool down these components in the projector 1 by creating some airflows 12. However, the abreast disposed fans 19, without partition, would cause interference between the airflows 12 created by the fans 19. The interference of the dragging airflows is disadvantageous in forming a preferred virtual airflow channel for the airflows 12 to travel along, thereby, reducing the cooling efficiency.

As mentioned above, conventional projectors are able to convert light, either in the projector (i.e. light leaking from the light source) or from the exterior (environmental light), into electric powers. Nevertheless, the cooling problems still need to be solved independently. Accordingly, this increases not only the interior components, but also the complexities of the molds and manufacturing costs.

As a result, an improved structure for sheltering light leakages, adequately using energy resources, and promoting cooling efficiencies is in need of development in this field.

### SUMMARY OF THE INVENTION

The primary objective of this invention is to provide a projection device, in which a solar cell panel is disposed, to receive light leakages from a light source and convert these light leakages into electric power for supplying other electric components. The airflow channel formed between the solar cell panel and either the light source or projector components (e.g. a power board, a ballast, or a housing) can simultaneously assist in guiding the airflows generated by the fans, thereby, promoting cooling efficiency in the housing and extending the life of the projection device.

Another objective of this invention is to provide a projection device, in which a solar cell panel is disposed. It not only effectively uses energy resources and promotes cooling efficiencies, but also shelters the light leakages outward the housing.

Yet a further objective of this invention is to provide a projection device. In addition to forming the airflow channel using the solar cell panel, promoting cooling efficiency, and sheltering light leakages, the projection device of the present invention could also reduce the complexity of the components (e.g. omit an airflow guiding plate). Furthermore, the costs of the molds can be reduced, increasing the product competitiveness.

To achieve the above-mentioned objectives, the projection device of the present invention comprises an end portion, a light source, a solar cell panel, a first airflow channel, and a first fan. The solar cell panel has a light receiving surface facing the light source for converting a portion of light, which is projected from the light source, into electric power. The first airflow channel is formed between the solar cell panel and the light source. The first fan is disposed on the end portion for generating a first airflow traveling along the first airflow channel during operation. Alternatively, the first airflow channel could be formed between the solar cell panel and a projector component.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the interior arrangement of a conventional projector;

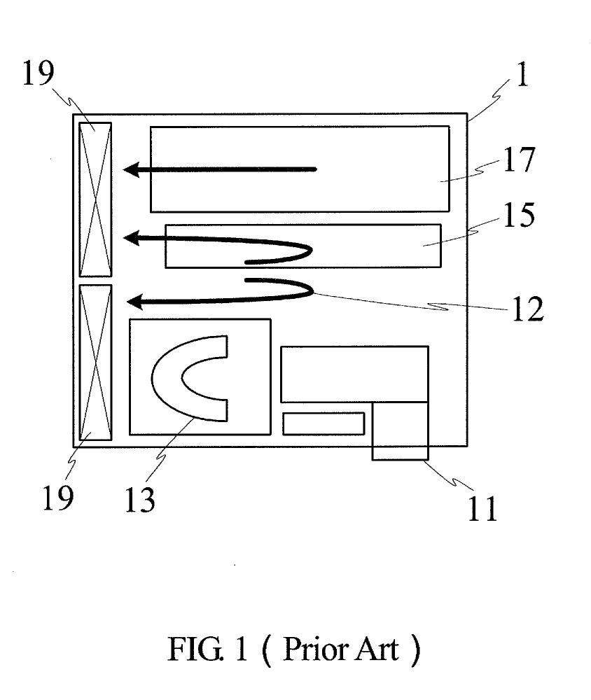

FIG. 2 is a schematic view illustrating a preferred embodiment of the present invention;

FIG. 3 is a schematic view illustrating another preferred embodiment of the present invention; and

FIG. 4 is a schematic view illustrating still a further preferred embodiment of the present invention.

### DESCRIPTION OF THE PREFERRED EMBODIMENT

The projection device 2 illustrated in the figures of the present invention is arranged three-dimensionally in reality. The so-called “airflow channels” are virtually defined without physical contours. They may refer to irregular three-dimension passage(s). Therefore, the designated numerals in the drawings may not be precisely indicated to the right places. The “cooling airflows” guided within the airflow channels, which are difficult to represent, are denoted by representative arrows.

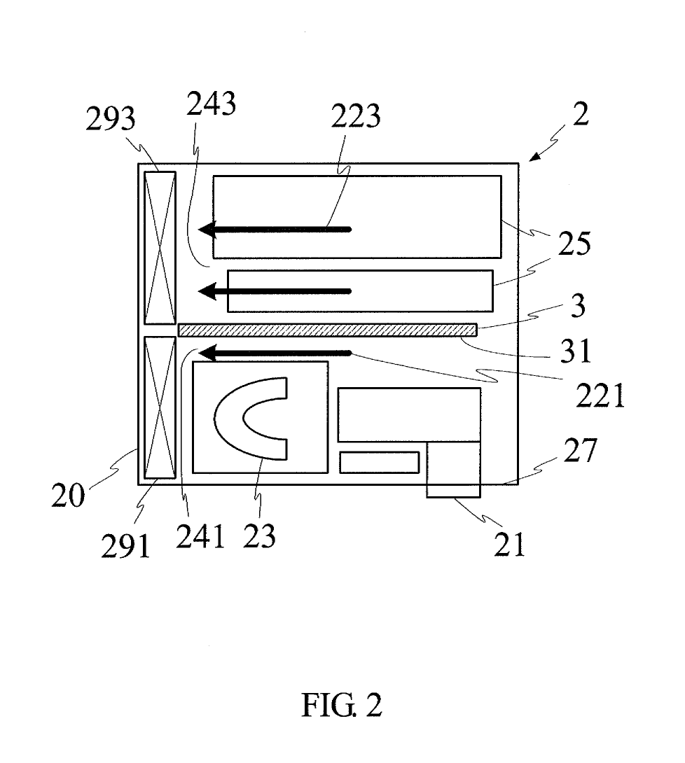

FIG. 2 is a schematic view illustrating a preferred embodiment of the present invention. The projection device 2 comprises an end portion 20, a light source 23, a solar cell panel 3, and a first fan 291. Preferably, the light source 23 is a bulb, which is utilized to provide sufficient light for an optical engine 21. The solar cell panel 3 has a light receiving surface 31 facing the light source 23 for converting a portion of light, which is projected from the light source 23 or the light from the exterior, into electric power. Furthermore, the projection device 2 of the present invention further comprises a first airflow channel 241, which is formed between the solar cell panel 3 and the light source 23. The first fan 291 is disposed on the end portion 20 for generating a first airflow 221 traveling along the first airflow channel 241 during operation.

For higher cooling efficiency, the projection device 2 further comprises a second fan 293, a second airflow channel 243, and at least a projector component 25. The second fan 293 is also disposed at the end portion 20 and arranged abreast of the first fan 291 for generating a second airflow 223 traveling along the second airflow channel 243 during operation. More specifically, the second airflow channel 243 is formed between the solar cell panel 3 and the projector component 25. In view of the solar cell panel 3, the second airflow channel 243 is substantially opposite to the first airflow channel 241. In other words, the solar cell panel 3 forms at least two airflow channels in the projection device 2 for cooling the light source 23 and the projector component 25, respectively.

Preferably, the solar cell panel 3 is disposed in a position that allows it to receive the light leaking from the light source 23 that are not utilized for illumination, and convert them into electric power. The electric power can be used to drive at least the first fan 291, the second fan 293, other projector components, or even the light source itself This preferred location of the solar cell panel 3 also provides a sheltering capability, which can shelter a portion of redundant light projecting from the light source 23.

It is even more preferable for both the above-mentioned first fan 291 and second fan 293 to be exhaust fans, as shown in the figures. These fans are adapted to guide the first airflow 221 and the second airflow 223 flowing through the first airflow channel 241 and the second airflow channel 243 in the projection device 2, respectively. Finally, the first airflow 221 and second airflow 223 are driven out of the projection device 2 through the exhaustion of the first fan 291 and the second fan 293.

The projector component 25 may include, but is not limited to, a plurality of optical components, such as a ballast, a power board, or a portion of a housing 27. The projector component is utilized to mutually form said airflow channels with the solar cell panel 3. Although the projector components 25 are clearly shown in the figures, the locations thereof are not limited. Two examples of related embodiments for the arrangement of the projector components are brought up in the following paragraphs.

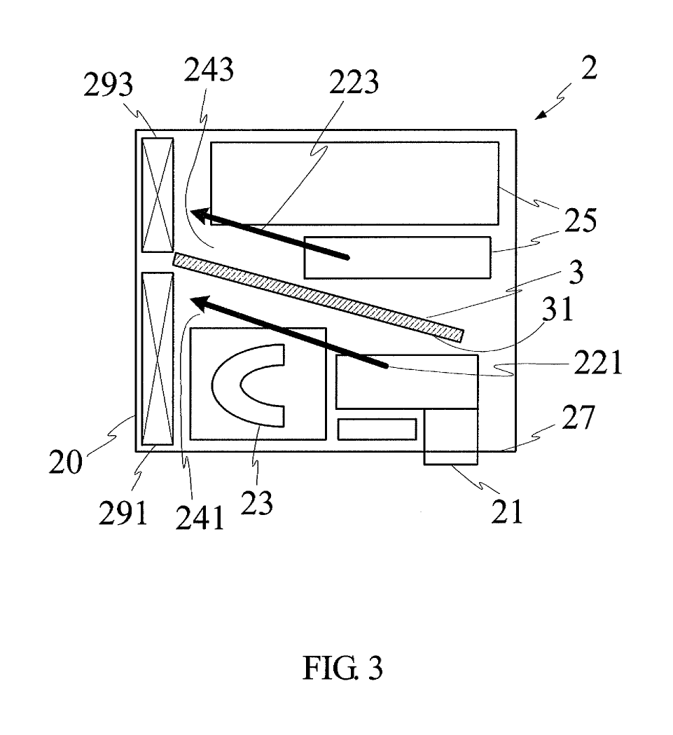

In FIG. 3, the solar cell panel 3 is disposed in the projection device 2 with other components. Specifically, the solar cell panel 3 is disposed at a deflection angle in correspondence with two differently sized fans 291, 293. Likewise, the solar cell panel 3 forms the first airflow channel 241 and the second airflow channel 243 for respectively providing appropriate cooling airflows for the light source 23 and the projector component 25.

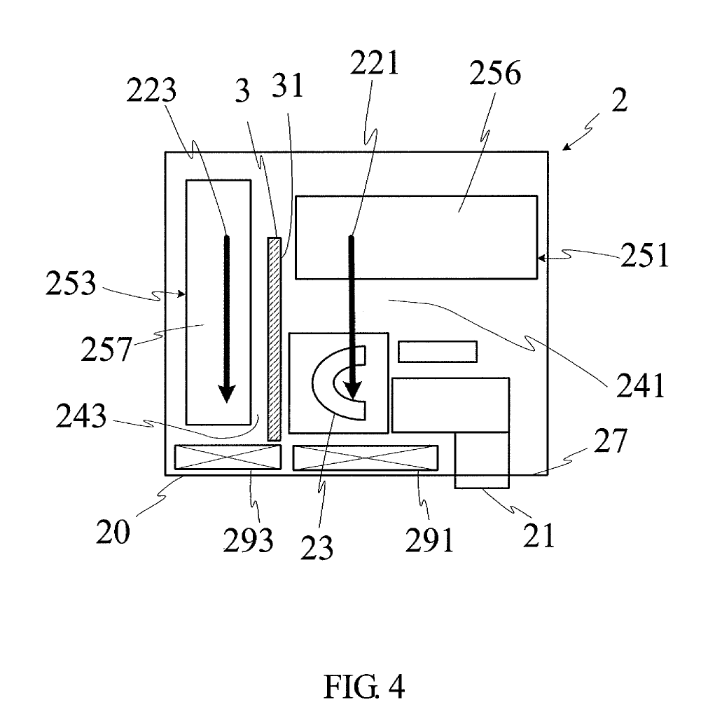

FIG. 4 illustrates still a further preferred embodiment of the present invention. The solar cell panel 3 partitions the interior of the projection device 2 into the first airflow channel 241 and the second airflow channel 243. More specifically, the first airflow channel 241 is formed between the solar cell panel 3 and a first projector component 251; the second airflow channel 243 is formed between the solar cell panel 3 and a second projector component 253. The first fan 291 is disposed on the end portion 20 for guiding the first airflow 221 along the first airflow channel 241. Likewise, the second fan 293 is disposed on the end portion 20 for guiding the second airflow 223 along the second airflow channel 243.

Ideally, both the first projector component 251 and the second projector component 253 should include a plurality of optical components. For example, the first projector component 251 could include, but not be limited to, an optical engine 21 and a ballast 256; whereas the second projector component 253 could include a power board 257. A portion of the housing 27 could co-define or respectively define the first airflow channel 241 and second airflow channel 243 with the first projector component 251 and the second projector component 253. Because the operations of this embodiment are similar to the above-mentioned embodiments, the repetitive descriptions are not given here.

The above disclosure is related to the detailed technical contents and inventive features thereof People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A projection device, comprising.
an end portion;
a light source;
a solar cell panel, having a light receiving surface, the light receiving surface facing the light source for converting a portion of light, which is projected from the light source, into electric power;
a first airflow channel, formed between the solar cell panel and the light source; and
a first fan, disposed on the end portion for generating a first airflow traveling along the first airflow channel during operation.

2. The projection device as claimed in claim 1, further comprising:
at least a projector component;
a second airflow channel, formed between the solar cell panel and at least the projector component, the second airflow channel substantially opposite to the first airflow channel in view of the solar cell panel; and
a second fan, disposed on the end portion for generating a second airflow traveling along the second airflow channel during operation.

3. The projection device as claimed in claim 2, wherein each of the first and second fans is an exhaust fan, in which the first fan and the second fan are adapted to exhaust outward the first airflow and the second airflow in the projection device through the first airflow channel and the second airflow channel, respectively.

4. The projection device as claimed in claim 1, wherein the solar cell panel is adapted to shelter another portion of light projected from the light source.

5. The projection device as claimed in claim 2, wherein the electric power converted from the solar cell panel is adapted to drive at least one of the first and second fans.

6. The projection device as claimed in claim 2, wherein the at least one projector component includes a plurality of optical components.

7. The projection device as claimed in claim 2, wherein the at least one projector component includes a ballast.

8. The projection device as claimed in claim 2, wherein the at least one projector component includes a power board.

9. The projection device as claimed in claim 2, further comprising a housing, in which the at least one projector component includes a portion of the housing.

10. A projection device, comprising:
an end portion;
a light source;
a solar cell panel, having a light receiving surface, the light receiving surface facing the light source for converting a portion of light, which is projected from the light source, into electric power;
a first projector component;
a first airflow channel, formed between the solar cell panel and the first projector component; and
a first fan, disposed on the end portion for generating a first airflow traveling along the first airflow channel during operation.

11. The projection device as claimed in claim 10, further comprising:
a second projector component;
a second airflow channel, formed between the solar cell panel and the second projector component, the second airflow channel substantially opposite to the first airflow channel in view of the solar cell panel; and
a second fan, disposed on the end portion for generating a second airflow traveling along the second airflow channel during operation.

12. The projection device as claimed in claim 11, wherein each of the first and second fans is an exhaust fan, in which the first fan and the second fan are adapted to exhaust outward the first airflow and the second airflow in the projection device through the first airflow channel and the second airflow channel, respectively.

13. The projection device as claimed in claim 10, wherein the solar cell panel is adapted to shelter another portion of light projected from the light source.

14. The projection device as claimed in claim 11, wherein the electric power converted from the solar cell panel is adapted to drive at least one of the first and second fans.

15. The projection device as claimed in claim 11, wherein each of the first and second projector components includes a plurality of optical components.

16. The projection device as claimed in claim 11, wherein the first projector component includes an optical engine.

17. The projection device as claimed in claim 11, wherein the first projector component includes a ballast.

18. The projection device as claimed in claim 11, wherein the second projector component includes a power board.

19. The projection device as claimed in claim 11, further comprising a housing, in which at least one of the first and second projector components includes at least a portion of the housing.
